(19) United States
(12) Patent Application Publication
(10) Pub. No.: US 2014/0077715 A1
(43) Pub. Date: Mar. 20, 2014

(54) SYSTEM CONTROL UNIT, LED DRIVER INCLUDING THE SYSTEM CONTROL UNIT, AND METHOD OF CONTROLLING STATIC CURRENT OF THE LED DRIVER

(71) Applicant: SILICON WORKS CO., LTD., Daejeon-si (KR)

(72) Inventors: Ok Hwan KWON, Daejeon-si (KR); Wanyuan QU, Daejeon-si (KR); Ju Pyo HONG, Daejeon-si (KR); Chang Sik SHIN, Daejeon-si (KR); Kyung Min KIM, Daejeon-si (KR); Byeong Ho JEONG, Daejeon-si (KR); Yong Goo KIM, Daejeon-si (KR); Young Suk SON, Daejeon-si (KR)

(73) Assignee: SILICON WORKS CO., LTD., Daejeon-si (KR)

(21) Appl. No.: 14/031,240

(22) Filed: Sep. 19, 2013

Related U.S. Application Data
(60) Provisional application No. 61/703,712, filed on Sep. 20, 2012.

(51) Int. Cl. H05B 33/08

(52) U.S. Cl. CPC H05B 33/0848
USPC 315/201; 315/297; 315/250

(57) ABSTRACT

Embodiments of the present invention provide a light-emitting diode (LED) driver for controlling a static current supplied to an LED array connected to a secondary coil of a transformer by using the peak values of currents flowing through a power transistor, which may reside in a switching element connected to a primary coil of the transformer. In some embodiments, the LED driver is configured to control the static current that flows through the LED array using an AC voltage supplied to the primary side of the transformer. In some embodiments, the LED driver includes a power conversion unit, a switching unit, a transformer, and a system control unit. In some embodiments, the method of controlling the static current of the LED driver includes a current peak value detection step, a step output current calculation step, a static current mean value calculation step, and a gate control signal update step.

### CROSS-REFERENCE TO RELATED APPLICATION

This non-provisional patent application claims priority to the provisional patent application having U.S. Ser. No. 61/703,712, filed on Sep. 20, 2012, the entire contents of which are incorporated herein by reference.

### BACKGROUND OF THE INVENTION

1. Field of the Invention

Embodiments of the present invention relate to a system control unit, a light-emitting diode (LED) driver including the system control unit, and a method of controlling static current for the LED driver. In some embodiments, the LED driver is configured to set a step output current corresponding to current that flows through an LED array using the peak values of each switching interval of current that flows through a power transistor connected to a primary coil of a transformer, and update a gate control signal for controlling the operation of the power transistor using the set step output current.

2. Description of the Related Art

LED lighting refers to a lighting apparatus configured to have static current flow through an LED and maintain constant luminosity. The luminosity of the LED can be adjusted by controlling the amount of static current that flows through the LED. If a mean current flowing through the LED is constant, it is said that the static current is controlled.

FIG. 1 is a circuit diagram of a conventional LED driver.

Referring to FIG. 1, the LED driver 100 includes a power conversion unit 110, a transformer 120, a switching unit 130, a system control unit 140, and a primary-side zero current detection unit 150.

A full-wave rectifier 111 of the power conversion unit 110 rectifies an AC voltage V_{ac} supplied to the primary side, and a DC input voltage V_{IN} is generated using the rectified voltage through a first capacitor C1. The switching unit 130 includes a power transistor Q1 and a switching resistor R_{S} that are coupled in series. The power transistor Q1 operates in response to a gate control signal V_{G}. The transformer 120 transfers the DC input voltage V_{IN}, generated from the power conversion unit 110, to the secondary side of the transformer 120 according to a turn ratio of the primary winding N_{P} and the secondary winding N_{S} of a coil that forms the transformer 120 depending on the switching operation of the power transistor Q1 connected to a primary coil of the transformer 120. The primary-side zero current detection unit 150 generates a resonant voltage V_{W} into which a value obtained by multiplying the sum of voltage V_{F} that drops to a diode D1 connected to a secondary coil of the transformer 120 and voltage V_{O} that drops to an LED array 160 connected to the secondary side by a ratio of a secondary-side winding N_{S} and an auxiliary winding Nₐ is incorporated in a process in which energy stored on the primary side of the transformer 120 is transferred to the secondary side, in particular, in an interval in which the power transistor Q1 is turned off.

The system control unit 140 includes an output current (I_{O}) estimator 141, a diode turn-on (To) interval estimator 142, a voltage (Vo) estimator 143, and a pulse width modulation (PWM) controller 144. The I_{O} estimator 141 estimates a current I_{O} that flows through the LED array 160 using voltage CS corresponding to a current I_{ds} that flows through the power transistor Q1. The diode turn-on interval estimator 142 estimates a time interval T_{D} in which the diode D1 connected to the secondary coil is turned on using a division voltage V_{S} obtained by dividing the resonant voltage V_{W} at a specific ratio. The Vo estimator 143 estimates voltage V_{O} that drops to the LED array 160 using a time interval T_{D} in which the diode D1 connected to the secondary coil is turned on and a division voltage V_{S} obtained by dividing a feedback voltage V_{W} at a specific ratio. The PWM controller 144 generates the gate control signal V_{G} that determines the amount of static current supplied to the LED array 160 using the voltage V_{O} that drops to the LED array 160.

FIG. 2 shows waveforms at a specific node of the LED driver shown in FIG. 1.

Referring to FIG. 2, the current I_{ds} that flows through the power transistor Q1 increases in an interval T_{ON} in which the power transistor Q1 is turned on in one unit interval T_{S} and does not flow in an interval T_{S}-T_{ON} in which the power transistor Q1 is turned off.

The diode D1 connected to the secondary coil is turned on at the moment when the power transistor Q1 is turned off, and thus the current I_{D} flowing through the diode D1 has a peak value I_{D}_{_{—}}ₚ of a diode current, having an amount obtained by multiplying a peak value Iₚₖ of the current I_{ds} that flows through the power transistor Q1 by a turn ratio N_{P}/N_{S} of the number of turns of the primary coil N_{P} and the number of turns of the secondary coil N_{S} that form the transformer 120. The current I_{D} flowing through the diode D1 connected to the secondary coil slowly decreases from the peak value I_{D}_{_{—}}_{P} of the diode current at the early stage of the turn-on and becomes a zero state when a point of time at which the diode D1 connected to the secondary coil is turned off.

The resonant voltage V_{W} has a negative voltage level when the power transistor Q1 is turned on, but has a voltage level, that is, a value obtained by multiplying the sum of the voltage V_{F} that drops to the diode D1 connected to the secondary coil and the voltage V_{O} that drops to the LED array 160 connected to the secondary side by a ratio of the secondary winding Nₛ and the auxiliary winding Nₐ at the moment when the power transistor Q1 is turned off and then has a constant resonance characteristic a point of time at which the diode D1 connected to the secondary coil is turned off. Here, the resonance characteristic refers to LC resonance between a parasitic capacitor (not shown), formed between the drain and source terminals of the power transistor Q1 that is turned off, and an inductor that forms the transformer 120.

In the case of the LED driver shown in FIG. 1, in order to generate the gate control signal V_{G}, all the peak value Iₚₖ of the current I_{ds} that flows through the power transistor Q1, the turn ratio N_{P}/N_{S} of the primary winding N_{P} and the secondary winding N_{S} of the coil that forms the transformer 120, one cycle T_{S} of the gate control signal V_{G}, and the turn-on interval T_{D} of the diode D1 on the secondary side must be known. Furthermore, there is a disadvantage in that a computational load is great and a circuit becomes complicated in order to generate a new gate control signal V_{G} using the values.

### SUMMARY OF SELECTED EMBODIMENTS OF THE INVENTION

Accordingly, embodiments of the present invention have been made in an effort to solve the problems occurring in the related art, and an object of some of these embodiments is to provide a system control unit for controlling a static current supplied to a LED array connected to a secondary coil of a transformer using the peak values of currents that flow through a power transistor, that is, a switching element connected to a primary coil of the transformer.

Another object is to provide an LED driver including the system control unit for controlling a static current supplied to a LED array connected to a secondary coil of a transformer using the peak values of currents that flow through a power transistor, that is, a switching element connected to a primary coil of the transformer.

Yet another object is to provide a method of controlling the static current of an LED driver, which controls static current supplied to an LED array connected to a secondary coil of a transformer using peak values of currents that flow through a power transistor, that is, a switching element connected to a primary coil of the transformer.

In order to achieve one or more of these objects, embodiments of the present invention provide a system control unit included in an LED driver, where the LED driver also includes a switching unit and a transformer. In such embodiments, the switching unit includes a power transistor configured to operate in response to a gate control signal, and a switching resistor placed between the power transistor and a ground voltage. The transformer is configured to transfer an input voltage to a secondary coil of the transformer at a specific ratio in response to a switching operation of the switching unit connected to a primary coil of the transformer. In addition, in such embodiments, the system control unit includes a current peak value arithmetic unit, a step output current setting unit, a mean value arithmetic unit, and a gate control signal update unit. In such embodiments, the current peak value arithmetic unit is configured to detect, for each switching interval in a plurality of switching intervals, a peak value of current flowing through the power transistor. The step output current setting unit is configured to set an amount of a step output current corresponding to current flowing through an LED array for a k^{th} (k is a natural number) switching interval in the plurality of switching intervals, as a peak value of current that flows through the power transistor and that is detected in a (k-1)^{th} switching interval. The mean value arithmetic unit is configured to calculate a static current mean value by averaging set step output currents within a predetermined set time interval. The gate control signal update unit is configured to update the gate control signal using the static current mean value.

Embodiments of the present invention also provide an LED driver having a power conversion unit, a switching unit, a transformer, and a system control unit. In such embodiments, the power conversion unit is configured to generate an input voltage by rectifying a supply voltage of an AC form. The switching unit includes a power transistor configured to operate in response to a gate control signal, and a switching resistor placed between the power transistor and a ground voltage. The transformer is configured to transfer the input voltage or a supply voltage of a DC form to a secondary coil of the transformer at a specific ratio in response to a switching operation of the switching unit connected to a primary coil of the transformer. The system control unit includes a current peak value arithmetic unit, a step output current setting unit, a mean value arithmetic unit, and a gate control signal update unit. In such embodiments, the current peak value arithmetic unit is configured to detect, for each switching interval in a plurality of switching intervals, a peak value of current flowing through the power transistor. The step output current setting unit is configured to set an amount of a step output current corresponding to current flowing through an LED array for a k^{th} (k is a natural number) switching interval in the plurality of switching intervals, as a peak value of current that flows through the power transistor and that is detected in a (k-1)^{th} switching interval. The mean value arithmetic unit is configured to calculate a static current mean value by averaging set step output currents within a predetermined set time interval. The gate control signal update unit is configured to update the gate control signal using the static current mean value.

Embodiments of the present invention also provide a method of controlling a static current of an LED driver, such as the LED driver described in the preceding paragraph. In such embodiments, the method includes a current peak value detection step, a step output current calculation step, a static current mean value calculation step, and a gate control signal update step. The current peak value detection step includes detecting, for each switching interval in the plurality of switching intervals, the peak value of current flowing through the power transistor. The step output current calculation step includes setting an amount of a step output current corresponding to current flowing through the LED array for a k^{th} (k is a natural number) switching interval, as a peak value of current that is detected in a (k-1)^{th} switching interval and flows through the power transistor. The static current mean value calculation step includes calculating a static current mean value by averaging set step output currents belonging to a predetermined set time interval. The gate control signal update step includes updating the gate control signal using the static current mean value.

### BRIEF DESCRIPTION OF THE DRAWINGS

The above objects and other features and advantages of embodiments of the present invention will become more apparent after reading the following detailed description taken in conjunction with the drawings, in which:

FIG. 1 is a circuit diagram of a conventional LED driver;

FIG. 2 shows waveforms at a specific node of the LED driver shown in FIG. 1;

FIG. 3 is a circuit diagram of an LED driver in accordance with an embodiment of the present invention;

FIG. 4 is a flowchart illustrating a method of controlling the static current of an LED driver in accordance with an embodiment of the present invention;

FIG. 5 shows electrical waveforms at a specific node of the LED driver in accordance with an embodiment of the present invention; and

FIG. 6 shows current that flows through a power transistor when an input voltage is a DC voltage having a great ripple.

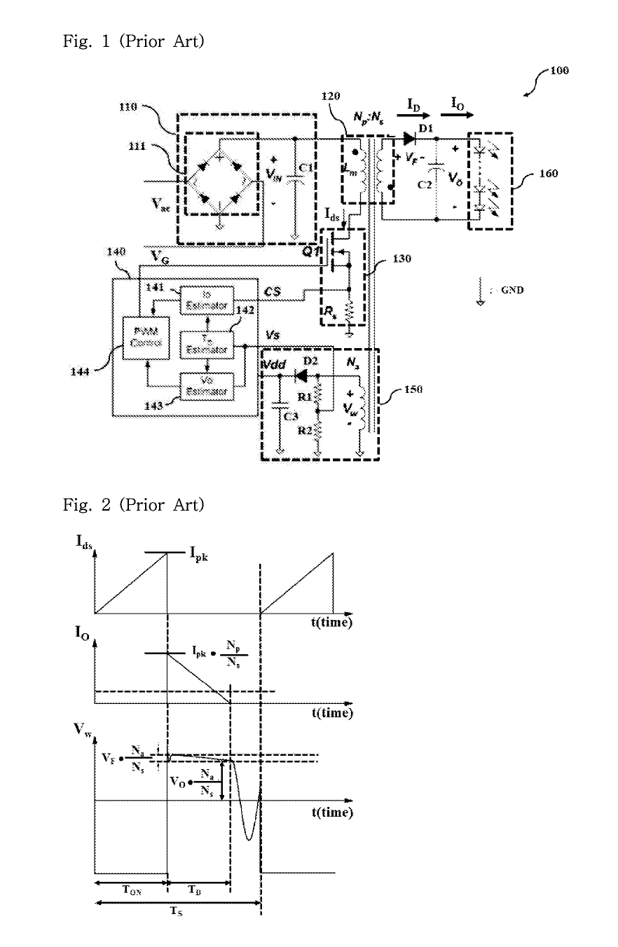

### DETAILED DESCRIPTION OF EMBODIMENTS OF THE INVENTION

Reference will now be made in greater detail to embodiments of the present invention, examples of which are illustrated in the accompanying drawings. Wherever possible, the same reference numerals will be used throughout the drawings and the description to refer to the same or like parts.

A core idea of some embodiments of the present invention is to set step output currents using a small number of parameters, that is, peak values of current that flows through a power transistor, that is, a switching element connected to a primary coil, calculate the mean value of static currents by averaging the values of step output currents belonging to a set time interval, and update a gate control signal using the calculated static current mean value.

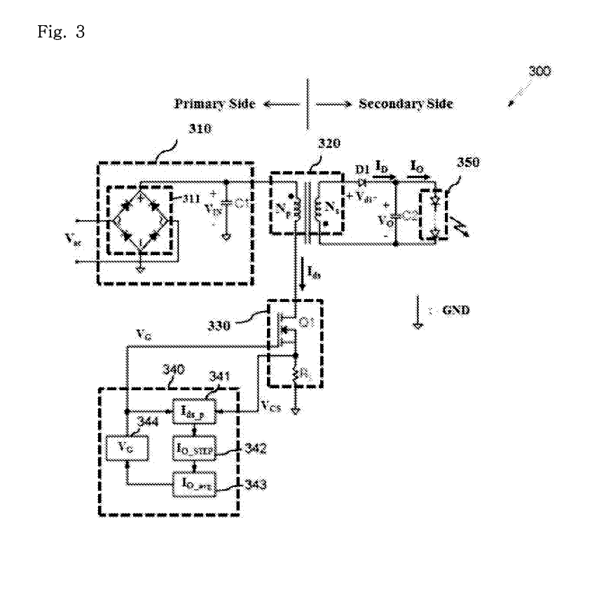

FIG. 3 is a circuit diagram of an LED driver in accordance with an embodiment of the present invention.

Referring to FIG. 3, the LED driver 300 includes a power conversion unit 310, a transformer 320, a switching unit 330, and a system control unit 340. In operation, the LED driver 300 is configured to transfer an input voltage V_{IN}, supplied to a primary coil of the transformer 320, to an LED array 350 connected to a circuit on the secondary side of the transformer 320.

In the present embodiment, a supply voltage supplied to the LED driver 300 is illustrated as being an AC voltage V_{ac}, but is not limited thereto. For example, the supply voltage may be a DC voltage. If the supply voltage is a DC voltage, the LED driver 300 of the present embodiment may not include the power conversion unit 310.

The power conversion unit 310 includes a full-wave rectifier 311 and a first capacitor C1 connected between the output terminal of the full-wave rectifier 311 and a ground GND. The power conversion unit 310 rectifies the AC voltage V_{ac} using the full-wave rectifier 311 and converts the rectified voltage of the first capacitor C1 into the input voltage V_{IN}. The input voltage V_{IN} becomes a DC voltage rarely having a ripple or a DC voltage having a very small ripple when the first capacitor C1 has a high capacitance, but may become a DC voltage having a great ripple when the first capacitor C1 has a low capacitance. The DC voltage having a great ripple includes voltage having a waveform that is substantially similar to the waveform of a rectified voltage. As will be described later, the LED driver 300 of the present embodiment can operate effectively when the input voltage V_{IN} is not only a DC voltage that does not have a ripple or has a small ripple, but also a DC voltage having a great ripple.

The transformer 320 transfers the input voltage V_{IN} to a secondary coil of the transformer 320 at a specific ratio in response to the switching operation of the switching unit 330 connected to the primary coil of the transformer 320. Assuming that the number of turns of the primary coil included in the transformer 320 is N_{P} and the number of turns of the secondary coil included therein is N_{S}, the specific ratio refers to a turn ratio of the number of turns N_{P} of the primary coil and the number of turns N_{S} of the secondary coil.

The switching unit 330 includes a power transistor Q1 configured to operate in response to a gate control signal V_{G}, and a switching resistor R_{S} placed between the power transistor Q1 and the ground GND. When the power transistor Q1 is in a turn-on state, current flows through on the primary side of the transformer 320, energy corresponding to the current is stored in the primary coil of the transformer 320, and the stored energy is transferred to the secondary coil of the transformer 320 according to a ratio of the number of turns of the primary coil and the number of turns of the secondary coil in an interval in which the power transistor Q1 is turned off.

The system control unit 340 detects the peak value of current that flows through the power transistor Q1 in each of the switching intervals of the switching unit 330, sets a step output current I_{O}_{_{—}}_{STEP} corresponding to current that flows through the LED array 350 connected to a circuit on the secondary side using a plurality of the consecutively detected peak values of the currents, and updates the gate control signal V_{G} using the set step output currents I_{O}_{_{—}}_{STEP}. Here, the current that flows through the power transistor Q1 is not measured by a current meter, but the current can be simply calculated using voltage V_{CS} that drops between the power transistor Q1 and the switching resistor R_{S} coupled in series to form the switching unit 330 and the resistance value of the switching resistor R_{S}.

In order to perform the above functions, the system control unit 340 includes a current peak value arithmetic unit 341, a step output current setting unit 342, a mean value arithmetic unit 343, and a gate control signal update unit 344.

The current peak value arithmetic unit 341 detects the peak value of current that flows through the power transistor Q1 in each switching interval. The step output current setting unit 342 sets the amount of a step output current I_{O}_{_{—}}_{STEP} corresponding to current flowing through the LED array 350 for a k^{th} (k is a natural number) switching interval, as the peak value I_{ds}_{_{—}}ₚ(k-1) of current that flows through the power transistor Q1 and that is detected in a (k-1)^{th} switching interval. As will be described later, since the step output current I_{O}_{_{—}}_{STEP} in one specific interval maintains the same amount as described above, the step output current I_{O}_{_{—}}_{STEP} has a stepwise waveform when integrally viewed from several intervals.

The mean value arithmetic unit 343 calculates a static current mean value I_{O}_{_{—}}_{avg} by averaging the values of step output currents I_{O}_{_{—}}_{STEP} that belong to a predetermined set time interval, from among a plurality of consecutive step output currents I_{O}_{_{—}}_{STEP}. The mean value arithmetic unit 343 can include a low pass filter for receiving the step output currents I_{O}_{_{—}}_{STEP} for a set time interval and for generating the static current mean value I_{O}_{_{—}}_{avg} using the received step output currents I_{O}_{_{—}}_{STEP}. The gate control signal update unit 344 updates the gate control signal V_{G} using the static current mean value I_{O}_{_{—}}_{avg}.

The set time interval may be set according to experiences or randomly, but it is preferably determined by the frequency of an AC voltage V_{ac} if the AC voltage V_{ac} rectified by the full-wave rectifier 311 has been converted into the input voltage V_{IN} of a DC form by the first capacitor C1 having a high capacitance.

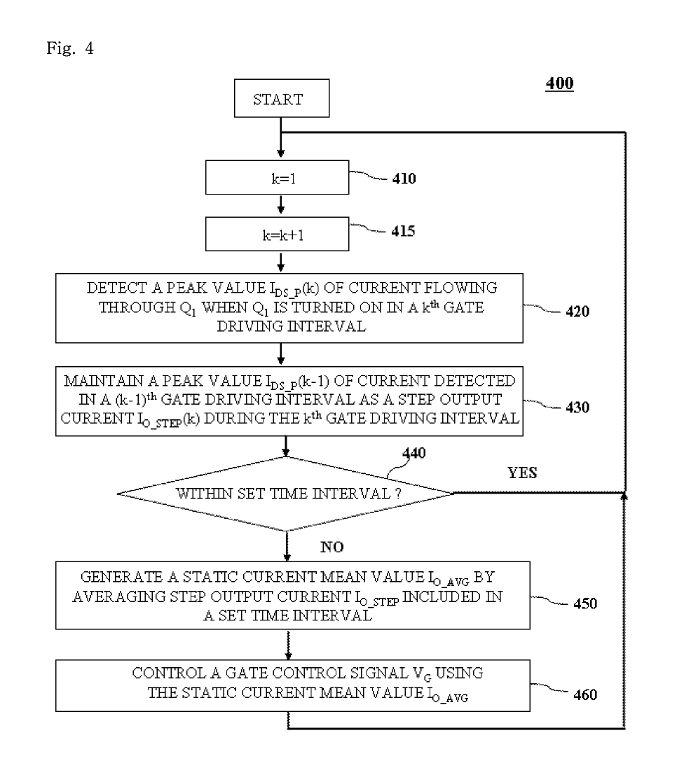

FIG. 4 is a flowchart illustrating a method of controlling the static current of an LED driver in accordance with an embodiment of the present invention.

Referring to FIG. 4, the method 400 of controlling the static current of the LED driver is applied to the LED driver 300 of FIG. 3. The method includes a current peak value detection step 420, a step output current calculation step 430, a predetermined set time interval determination step 440, a static current mean value calculation step 450, and a gate control signal update step 460.

In the current peak value detection step 420, the peak value of current that flows through the power transistor Q1 in each switching interval is detected. In the step output current calculation step 430, the amount of a step output current I_{O}_{_{—}}_{STEP} corresponding to current that flows through the LED array 350 for a k^{th} (k is a natural number) switching interval is set as the peak value I_{ds}_{_{—p}}(k-1) of current that flows through the power transistor Q1 and that is detected in a (k-1)^{th} switching interval.

In the predetermined set time interval determination step 440, if a plurality of the consecutive step output currents I_{O}_{_{—}}_{STEP} is included in a predetermined set time interval (YES), the current peak value detection step 420 and the step output current calculation step 430 are performed. If the plurality of consecutive step output currents I_{O}_{_{—}}_{STEP} are not included in the predetermined set time interval (NO), the static current mean value calculation step 450 is performed.

In the static current mean value calculation step 450, the static current mean value I_{O}_{_{—}}_{avg} is calculated by averaging the values of step output currents I_{O}_{_{—}}_{STEP} that belong to the predetermined set time interval, from among the plurality of consecutive step output currents I_{O}_{_{—}}_{STEP}. In the gate control signal update step 460, the gate control signal V_{G} is updated using the static current mean value I_{O}_{_{—}}_{avg}.

Here, a method of estimating current flowing through the power transistor Q1 for the predetermined set time interval and the specific ratio are the same as those of FIG. 3 described with reference to the LED driver 300, and thus a description thereof is omitted.

At least one of the current peak value detection step 420, the step output current calculation step 430, the predetermined set time interval determination step 440, the static current mean value calculation step 450, and the gate control signal update step 460 is repeatedly performed while the LED driver 300 supplies a static current to the LED array 350.

In FIG. 4, a parameter setting step 410 is a step of resetting a parameter k to 1 (i.e., k=1). A step of increasing a value allocated to the parameter k 415 is used to increase the parameter by 1 while operation is performed. The steps are commonly used in a signal flowchart, and thus a detailed description thereof is omitted.

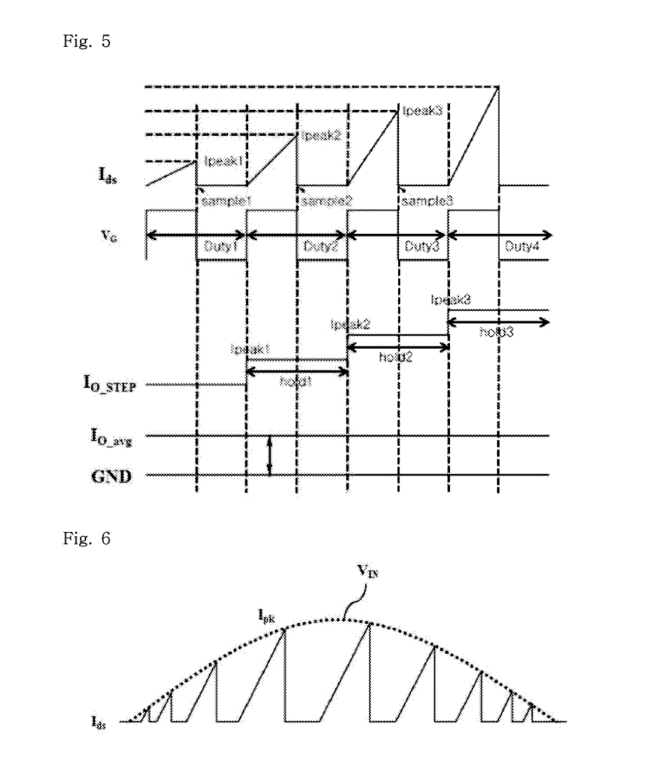

FIG. 5 shows electrical waveforms at a specific node of the LED driver in accordance with an embodiment of the present invention.

Referring to FIG. 5, the current I_{ds} flowing through the power transistor Q1 rises in an interval in which the gate control signal V_{G} is turned on and has a zero value in an interval in which the gate control signal V_{G} is turned off. FIG. 5 shows a plurality of switching intervals Duty1-Duty3. At the moment when the gate control signal V_{G} shifts from the turn-on state to the turn-off state in each switching interval, the current I_{ds} flowing through the power transistor Q1 is sampled.

The current I_{ds} that flows through the power transistor Q1 at the sampling moment will become the peak value Iₚₑₐₖ of the current flowing through the power transistor Q1. Here, the peak value Iₚₑₐₖ of the sampled current flowing through the power transistor Q1 is incorporated into the next switching interval. Referring to FIG. 5, in the first switching interval Duty1, a sampled peak value Iₚₑₐₖ₁ is incorporated into the second switching interval Duty2, and thus the sampled peak value Iₚₑₐₖ₁ remains intact (hold1). Likewise, in the second switching interval Duty2 and the third switching interval Duty3, sampled peak values Iₚₑₐₖ₂ and Iₚₑₐₖ₃ are incorporated into the third switching interval Duty3 and the fourth switching interval Duty4, respectively, and thus the sampled peak values Iₚₑₐₖ₂ and Iₚₑₐₖ₃ remain intact (hold2 and hold3).

From FIG. 5, it can be seen that the step output currents I_{O}_{_{—}}_{STEP} have a stepwise waveform. There is a slight difference between the time when current is sampled and the time when the current is held, but the difference is negligible when a sampling frequency is taken into consideration.

The static current mean value I_{O}_{_{—}}_{avg} can be calculated by averaging the step output currents I_{O}_{_{—}}_{STEP} for a specific time interval using an averaging device, such as a low pass filter, as described above.

Embodiments of the present invention can be effective when the input voltage V_{IN} is not only DC, but also AC, and a reason thereof is described below.

FIG. 6 shows current that flows through the power transistor when an input voltage V_{IN} is a DC voltage having a great ripple.

Referring to FIG. 6, the current I_{ds} flowing through the power transistor Q1 has a saw-toothed form. The input voltage V_{IN} having a waveform of a rectified voltage form is obtained by connecting the highest points of the saw-toothed form.

If the input voltage V_{IN} is a DC voltage having a great ripple, voltage having a waveform of a rectified voltage form is applied to the transformer 320. In general, the AC current V_{ac} supplied to the LED driver has a frequency 50-60 Hz. The gate control signal V_{G} for controlling the operation of the power transistor Q1 has a frequency of several tens of KHz, and thus the current I_{ds} flowing through the power transistor Q1 has a form, such as that shown in FIG. 6.

In this case, current flowing through the secondary side becomes the product of the peak value Iₚₖ and a ratio of the number of turns of the primary coil and the number of turns of the secondary coil of the transformer 320. Accordingly, a power factor has to be corrected because current on the secondary side has the same form as current on the primary side. In the prior art, a complicated operation for correcting the power factor must be performed every switching interval because the turn-on and turn-off cycle of the power transistor Q1 is varied.

In accordance with an embodiment of the present invention, this power factor correction is not necessary because the mean value of currents supplied to the LED array 350 is calculated.

In the LED driver and the method of controlling the static current of the LED driver in accordance with some embodiments of the present invention, the gate control signal is controlled using one parameter, that is, the peak value of current that flows through the power transistor, that is, a switching element connected to the primary coil. Accordingly, the hardware necessary for operation is simple because the operation itself is not complicated.

Furthermore, if an input current does not have a DC form, but an AC form, a static current on the secondary side can be effectively controlled. In this case, a power factor can be improved as compared with a case where the input current has a DC form.

Although some embodiments of the present invention have been described for illustrative purposes, those skilled in the art will appreciate that various modifications, additions, and substitutions are possible, without departing from the scope and the spirit of the invention as disclosed in the accompanying claims.

What is claimed is:

1. A system control unit included in a light-emitting diode (LED) driver, the LED driver also comprising a switching unit and a transformer, wherein the switching unit comprises a power transistor configured to operate in response to a gate control signal, and a switching resistor placed between the power transistor and a ground voltage, and wherein the transformer is configured to transfer an input voltage to a secondary coil of the transformer at a specific ratio in response to a switching operation of the switching unit connected to a primary coil of the transformer, wherein the system control unit comprises:
a current peak value arithmetic unit configured to detect, for each switching interval in a plurality of switching intervals, a peak value of current flowing through the power transistor;
a step output current setting unit configured to set an amount of a step output current corresponding to current flowing through an LED array for a k^{th} (k is a natural number) switching interval in the plurality of switching intervals, as a peak value of current that flows through the power transistor and that is detected in a (k-1)^{th} switching interval;
a mean value arithmetic unit configured to calculate a static current mean value by averaging set step output currents within a predetermined set time interval; and
a gate control signal update unit configured to update the gate control signal using the static current mean value.

2. The system control unit of claim 1, wherein the mean value arithmetic unit comprises a low pass filter configured to receive the step output currents for the predetermined set time interval and to generate the static current mean value using the received step output currents.

3. The system control unit of claim 1, wherein the current flowing through the power transistor is estimated using voltage that drops between the power transistor and the switching resistor and a resistance value of the switching resistor.

4. The system control unit of claim 1, wherein the specific ratio is a ratio of a number of turns of the primary coil and a number of turns of the secondary coil that form the transformer.

5. An LED driver, comprising:
a power conversion unit configured to generate an input voltage by rectifying a supply voltage of an AC form;
a switching unit comprising a power transistor configured to operate in response to a gate control signal, and a switching resistor placed between the power transistor and a ground voltage;
a transformer configured to transfer the input voltage or a supply voltage of a DC form to a secondary coil of the transformer at a specific ratio in response to a switching operation of the switching unit connected to a primary coil of the transformer; and
a system control unit comprising:
a current peak value arithmetic unit configured to detect, for each switching interval in a plurality of switching intervals, a peak value of current flowing through the power transistor;
a step output current setting unit configured to set an amount of a step output current corresponding to current flowing through an LED array for a k^{th} (k is a natural number) switching interval in the plurality of switching intervals, as a peak value of current that flows through the power transistor and that is detected in a (k-1)^{th} switching interval;
a mean value arithmetic unit configured to calculate a static current mean value by averaging set step output currents within a predetermined set time interval; and
a gate control signal update unit configured to update the gate control signal using the static current mean value.

6. The LED driver of claim 5, wherein the mean value arithmetic unit comprises a low pass filter configured to receive the step output currents for the predetermined set time interval and to generate the static current mean value using the received step output currents.

7. The LED driver of claim 5, wherein the predetermined set time interval is determined by a frequency of an AC voltage.

8. The LED driver of claim 5, wherein the current flowing through the power transistor is estimated using voltage that drops between the power transistor and the switching resistor and a resistance value of the switching resistor.

9. The LED driver of claim 5, wherein the specific ratio is a ratio of a number of turns of the primary coil and a number of turns of the secondary coil that form the transformer.

10. A method of controlling a static current of the LED driver according to claim 5, the method comprising:
a current peak value detection step of detecting, for each switching interval in the plurality of switching intervals, the peak value of current flowing through the power transistor;
a step output current calculation step of setting an amount of a step output current corresponding to current flowing through the LED array for a k^{th} (k is a natural number) switching interval, as a peak value of current that is detected in a (k-1)^{th} switching interval and flows through the power transistor;
a static current mean value calculation step of calculating a static current mean value by averaging set step output currents belonging to a predetermined set time interval; and
a gate control signal update step of updating the gate control signal using the static current mean value.

11. The method of claim 10, wherein the predetermined set time interval is determined by a frequency of an AC voltage.

12. The method of claim 10, further comprising a predetermined set time interval determination step of performing the current peak value detection step and the step output current calculation step if a plurality of consecutive set step output currents is included in the predetermined set time interval, and performing the static current mean value calculation step if the plurality of consecutive set step output currents is not included in the predetermined set time interval.

13. The method of claim 10, wherein the current peak value detection step, the step output current calculation step, the static current mean value calculation step, and the gate control signal update step are repeatedly performed while the LED driver supplies the static current to the LED array.

14. The method of claim 10, wherein the current flowing through the power transistor is estimated using voltage that drops between the power transistor and the switching resistor and a resistance value of the switching resistor.

15. The method of claim 10, wherein the specific ratio is a ratio of a number of turns of the primary coil and a number of turns of the secondary coil that form the transformer.
